(19) United States
(12) Patent Application Publication
(10) Pub. No.: US 2009/0168616 A1
(43) Pub. Date: Jul. 2, 2009

(54) SPHERICAL ABERRATION COMPENSATION METHOD OF OPTICAL STORAGE DEVICE

(76) Inventors: Yi-Jen Chung, Hsinchu City (TW); Cheng-Chi Huang, Hsinchu County (TW); Chao-Ming Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/964,047

(22) Filed: Dec. 26, 2007

(51) Int. Cl. G11B 7/00

(52) U.S. Cl. 369/44.32

(57) ABSTRACT

A spherical aberration compensation method of an optical storage device is provided. The method includes: deriving a first spherical aberration compensation value corresponding to a first track position on a recording layer of an optical storage medium to serve as a first reference value; deriving a second spherical aberration compensation value corresponding to a second track position on the recording layer of the optical storage medium to serve as a second reference value; and estimating a third spherical aberration compensation value corresponding to a third track position on the recording layer of the optical storage medium according to the first and second reference values.

### BACKGROUND

The present invention relates to improving data recording quality and/or data reproduction quality of an optical storage device, and more particularly, to a spherical aberration compensation method of an optical storage device (e.g., an optical disc drive).

In recent years, as a recording medium for recording digital data, an optical disc is generally used. With increasing demands for larger storage capacity, traditional optical discs, such as compact discs (CDs) and digital versatile discs (DVDs), no longer satisfy user requirements. Blu-ray discs (BDs) and high density digital versatile discs (HD-DVDs) providing large data storage capacities therefore have become future trends. Additionally, to provide further larger storage capacity, the multi-layer BDs and HD-DVDs having multiple recording layers have been developed as well.

The recording and reproduction of data onto/from the optical disc are executed by irradiating a laser beam onto one recording layer of the optical disc from an optical pickup unit (OPU). That is, the laser beam is converged onto the recording layer and a light spot is formed on the recording layer. In the optical pickup unit, the laser beam is irradiated from a laser beam source (e.g., a laser diode), enters an objective lens through a beam splitter or the like, and is converged by the objective lens, thereby forming the desired light spot onto the recording layer of the optical disc. Therefore, the quality of the light spot focused on the recording layer of the optical disc dominates the overall performance of the optical disc drive. For example, when spherical aberration occurs, it is possible that a blurred and unrecognizable image of the laser spot is detected by the optical pickup unit. It is very important to compensate the spherical aberration in an optical storage device; otherwise, the recording and/or reproduction quality might be greatly degraded due to the spherical aberration.

### SUMMARY

It is therefore one of the objectives of the present invention to provide a spherical aberration compensation method of an optical storage device (e.g., an optical disc drive) to improve the data recording quality and/or data reproduction quality.

According to one aspect of the present invention, a spherical aberration compensation method of an optical storage device is provided. The method includes deriving a first spherical aberration compensation value corresponding to a first track position on a recording layer of an optical storage medium to serve as a first reference value; deriving a second spherical aberration compensation value corresponding to a second track position on the recording layer of the optical storage medium to serve as a second reference value; and estimating a third spherical aberration compensation value corresponding to a third track position on the recording layer of the optical storage medium according to the first and second reference values.

According to another aspect of the present invention, a spherical aberration compensation method of an optical storage device is provided. The method includes applying a default spherical aberration compensation value to the optical storage device and then checking a signal quality corresponding a reflected signal read by the optical storage device from a specific track position on a recording layer of an optical storage medium to generate a checking result; when the checking result meets a predetermine criterion, utilizing the default spherical aberration compensation value to serve as a target spherical aberration compensation value corresponding to the specific track position on the recording layer of the optical storage medium; and when the checking result does not meet the predetermine criterion, performing a spherical aberration calibration at the specific track position on the recording layer of the optical storage medium to derive the target spherical aberration compensation value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram illustrating an exemplary optical storage device with spherical aberration compensation capability according to the present invention.

FIG. 2 is a flowchart illustrating a spherical aberration compensation method according to a first exemplary embodiment of the present invention.

FIG. 3 is a flowchart illustrating a spherical aberration compensation method according to a second exemplary embodiment of the present invention.

FIG. 4 is a continued flowchart of the flow shown in FIG. 3.

FIG. 5 is a flowchart illustrating a spherical aberration compensation method according to a third exemplary embodiment of the present invention.

FIG. 6 is a continued flowchart of the flow shown in FIG. 5.

FIG. 7 is a flowchart illustrating a spherical aberration compensation method according to a fourth exemplary embodiment of the present invention.

FIG. 8 is a continued flowchart of the flow shown in FIG. 7.

FIG. 9 is a continued flowchart of the flow shown in FIG. 8.

FIG. 10 is a diagram illustrating operation of determining the spherical aberration compensation value according to the embodiment shown in FIG. 7-FIG. 9.

### DETAILED DESCRIPTION

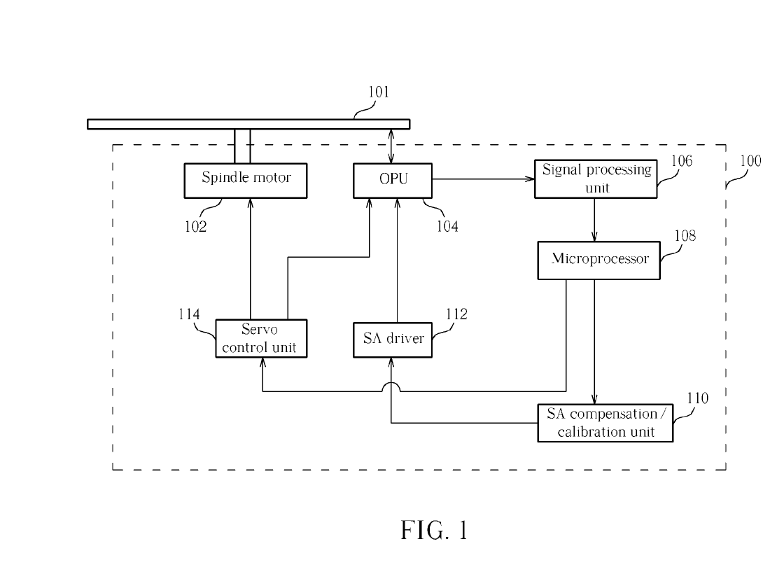

Please refer to FIG. 1. FIG. 1 is a simplified block diagram illustrating an exemplary optical storage device with spherical aberration compensation capability according to the present invention. The optical storage device (e.g., an optical disc drive 100) includes, but is not limited to, a spindle motor 102 implemented for rotating an optical storage medium (e.g., an optical disc 101) at desired rotational speed; an optical pickup unit (OPU) 104 implemented for irradiating a laser beam onto a target recording layer of the optical disc 101 and then detecting reflected laser beam from the target recording layer of the optical disc 101; a signal processing unit 106 implemented for processing signals detected and outputted from the OPU 104; a microprocessor 108 implemented for control overall operation of the optical disc drive 100; a spherical aberration (SA) compensation/calibration unit 110 implemented for estimating an SA compensation value; an SA driver 112 implemented for compensating the spherical aberration according to the SA compensation value determined by the SA compensation/calibration unit 110; and a servo control unit 114 implemented for having servo control over the spindle motor 102 (e.g., spindle control) and the OPU 104 (e.g., focusing control and tracking control). As one can see, to achieve optimized spherical aberration compensation, it is important to provide an appropriate SA compensation value set to the SA driver 112. In a conventional implementation of SA compensation, a single SA compensation value is calibrated at a specific track position on a recording layer of the loaded optical disc, and then it is referenced for SA compensation when the optical pickup unit accesses any track position on the recording layer of the optical disc. Compared with the conventional SA compensation scheme, the spherical aberration compensation/calibration unit 110 of the exemplary optical disc drive 100 employs a novel scheme of determining the SA compensation value. Further details are given as follows.

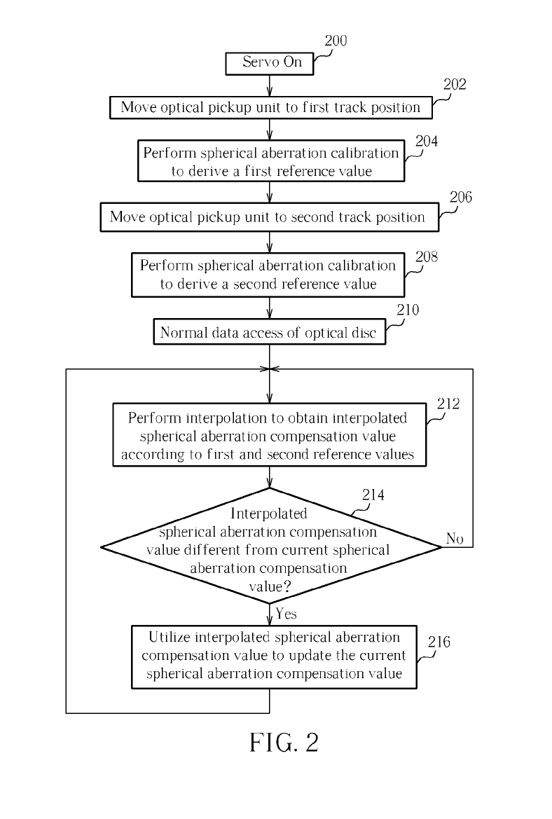

Please refer to FIG. 2 in conjunction with FIG. 1. FIG. 2 is a flowchart illustrating a spherical aberration compensation method according to a first exemplary embodiment of the present invention. Provided that the result is substantially the same, the steps are not limited to be executed in the exact order shown in FIG. 2. That is, modifications made to the flow shown in FIG. 2 without departing from the spirit of the present invention are possible. The exemplary spherical aberration compensation method includes following steps:
Step 200: Enable the servo control unit 114.
Step 202: Move the OPU 104 to a first track position (e.g., an inner track) on a recording layer of the optical disc 101.
Step 204: Perform spherical aberration calibration at the first track position (e.g., the inner track) to derive a first spherical aberration compensation value serving as a first reference value.
Step 206: Move the OPU 104 to a second track position (e.g., an outer track) on the recording layer of the optical disc 101.
Step 208: Perform a spherical aberration calibration at the second track position (e.g., the outer track) to derive a second spherical aberration compensation value serving as a second reference value.
Step 210: Start normal data access of the optical disc 101.
Step 212: Perform an interpolation to obtain a third spherical aberration compensation value (i.e., an interpolated spherical aberration compensation value) corresponding to a third track position (i.e., a current track position during the normal data access) on the recording layer of the optical disc 101 according to the first and second reference values.
Step 214: Check if the third spherical aberration compensation value (i.e., the interpolated spherical aberration compensation value) is different from a current spherical aberration compensation value. If yes, go to Step 216; otherwise, go to Step 212.
Step 216: Utilize the third spherical aberration compensation value (i.e., the interpolated spherical aberration compensation value) to update the current spherical aberration compensation value, and then go to Step 212.

The operation of the above spherical aberration compensation method is detailed as below. In the beginning, the microprocessor 108 controls the servo control unit 114 to turn on the servo control (Step 200). Next, the SA compensation/calibration unit 110, in one embodiment of the present invention, first applies the spherical aberration calibration to the inner track position of the optical disc 101 and then the outer track position of the optical disc 101. Therefore, the OPU 104 is first moved to a first track position, and then the microprocessor 108 instructs the SA compensation/calibration unit 110 to activate the spherical aberration calibration, thereby deriving a first spherical aberration compensation value serving as a first reference value (Steps 202 and 204). Next, the OPU 104 is moved to a second track position, and then the microprocessor 108 instructs the SA compensation/calibration unit 110 to activate the spherical aberration calibration, thereby deriving a second spherical aberration compensation value serving as a second reference value (Steps 206 and 208). It should be noted that the first and second track positions are programmable depending upon design requirements. In addition, the order of performing the spherical aberration calibration at the first and second track positions is not limited to above exemplary embodiment. For instant, in an alternative embodiment of the present invention, the spherical aberration calibration is first applied to the outer track position of the optical disc 101 and then the inner track position of the optical disc 101. This also falls in the scope of the present invention. Furthermore, deriving two reference values at different track positions through spherical aberration calibration merely serves as an example. Any implementations deriving a plurality of reference values at different track positions on the same recording layer through spherical aberration calibration fall in the scope of the present invention. It should be noted that any conventional spherical aberration calibration can be employed for deriving the aforementioned first and second reference values. Further details of the spherical aberration calibration are omitted here for brevity.

After the first and second reference values are successfully obtained through spherical aberration calibration under the control of the SA compensation/calibration unit 110, the normal data access of the optical disc 101 is started (Step 210). Suppose that the first reference value is used to act as initial setting of the spherical aberration compensation value during the normal data access operation. In Step 212, the SA compensation/calibration unit 110 performs an interpolation to obtain a third spherical aberration compensation value corresponding to a third track position (i.e., a current track position) on the recording layer of the optical disc 101 according to the first (inner), second (outer), and third (current) track positions and the first and second reference values. Next, the SA compensation/calibration unit 110 checks if the third spherical aberration compensation value obtained by interpolation using the first and second reference values is different from the current spherical aberration compensation value set to the SA driver 112 (Step 214). If the interpolated spherical aberration compensation value is identical to the current spherical aberration compensation value used by the SA driver 112, the SA compensation/calibration unit 110 does not change the current spherical aberration compensation setting; otherwise, the SA compensation/calibration unit 110 outputs the third spherical aberration compensation value (i.e., the interpolated spherical aberration compensation value) to the SA driver 112 for changing the current spherical aberration compensation value, thereby adjusting actual spherical aberration compensation applied to the optical disc drive 100 accordingly (Step 216).

Briefly summarized, the spherical aberration compensation method shown in FIG. 2 obtains a plurality of reference values through spherical aberration calibrations applied to different track positions on a recording layer of the optical disc, and then computes a spherical aberration compensation value at a specific track position on the optical disc by interpolation. In this way, the objective of providing real-time spherical aberration compensation is achieved.

In above exemplary implementation, the spherical aberration compensation method is applied to a single-layer optical disc. However, the same concept can be applied to a multi-layer optical disc. An example of performing spherical aberration compensation upon a double-layer optical disc is given as below.

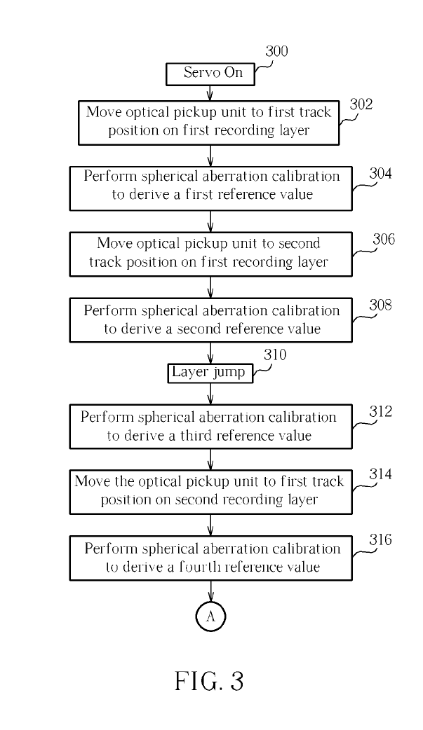

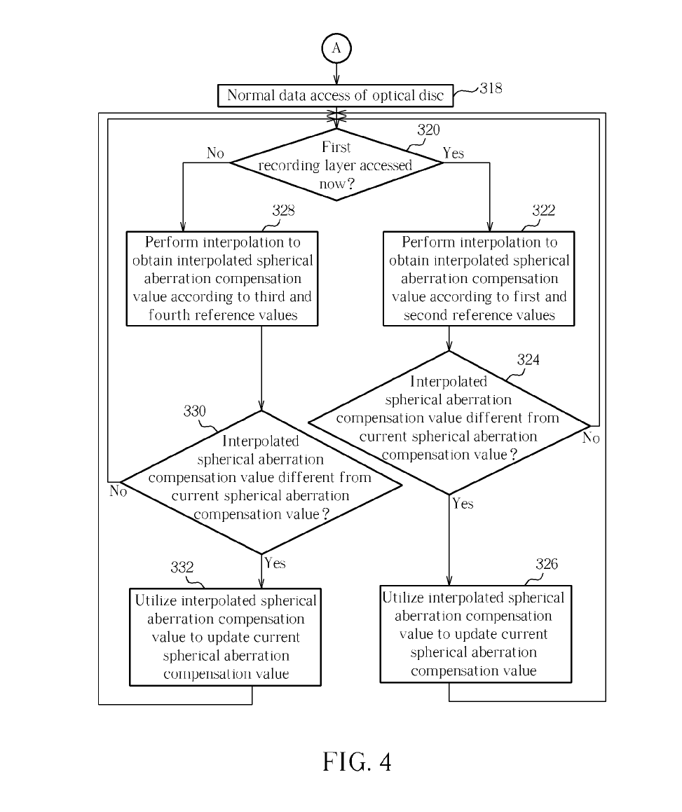

FIG. 3 is a flowchart illustrating a spherical aberration compensation method according to a second exemplary embodiment of the present invention. FIG. 4 is a continued flowchart of the flow shown in FIG. 3. Provided that the result is substantially the same, the steps are not limited to be executed in the exact order shown in FIG. 3 and FIG. 4. The exemplary spherical aberration compensation method includes following steps:
Step 300: Enable the servo control unit 114.
Step 302: Move the OPU 104 to a first track position (e.g., an inner track) on a first recording layer of the optical disc 101.
Step 304: Perform spherical aberration calibration at the first track position (e.g., the inner track) to derive a first spherical aberration compensation value serving as a first reference value.
Step 306: Move the OPU 104 to a second track position (e.g., an outer track) on the first recording layer of the optical disc 101.
Step 308: Perform spherical aberration calibration at the second track position (e.g., the outer track) to derive a second spherical aberration compensation value serving as a second reference value.
Step 310: Perform a layer jump to move a laser spot converged on the first recording layer to a second recording layer of the optical disc 101.
Step 312: Perform spherical aberration calibration at the second track position (e.g., the outer track) on the second recording layer to derive a third spherical aberration compensation value serving as a third reference value.
Step 314: Move the OPU 104 to the first track position (e.g., the inner track) on the second recording layer of the optical disc 101.
Step 316: Perform spherical aberration calibration at the first track position (e.g., the inner track) on the second recording layer to derive a fourth spherical aberration compensation value serving as a fourth reference value.
Step 318: Start normal data access of the optical disc 101.
Step 320: Is the first recording layer accessed now? If yes, go to Step 322; otherwise, go to Step 328.
Step 322: Perform an interpolation to obtain a fifth spherical aberration compensation value (i.e., an interpolated spherical aberration compensation value) corresponding to a third track position (i.e., a current track position during the normal data access) on the first recording layer of the optical disc 101 according to the first and second reference values.
Step 324: Check if the fifth spherical aberration compensation value (i.e., the interpolated spherical aberration compensation value) is different from a current spherical aberration compensation value. If yes, go to Step 326; otherwise, go to Step 320.
Step 326: Utilize the fifth spherical aberration compensation value (i.e., the interpolated spherical aberration compensation value) to update the current spherical aberration compensation value. Go to Step 320.
Step 328: Perform an interpolation to obtain a sixth spherical aberration compensation value corresponding to a sixth track position (i.e., a current track position during the normal data access) on the second recording layer of the optical disc 101 according to the third and fourth reference values.
Step 330: Check if the sixth spherical aberration compensation value (i.e., the interpolated spherical aberration compensation value) is different from a current spherical aberration compensation value. If yes, go to Step 332; otherwise, go to Step 320.
Step 332: Utilize the sixth spherical aberration compensation value (i.e., the interpolated spherical aberration compensation value) to update the current spherical aberration compensation value. Go to Step 320.

As a skilled person can readily understand the operation of each step in FIG. 3 and FIG. 4 after reading above paragraphs directed to the exemplary embodiment of performing spherical aberration compensation upon a single-layer optical disc, further description is omitted here for brevity.

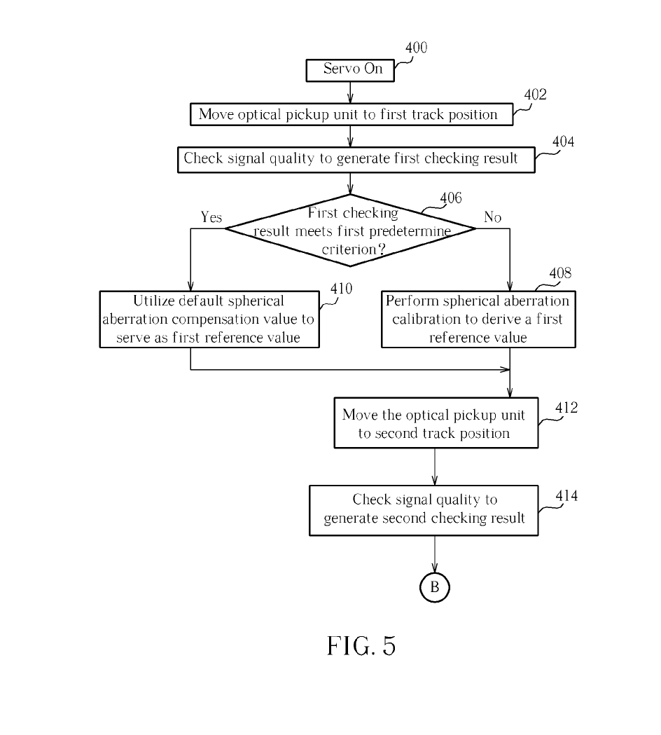

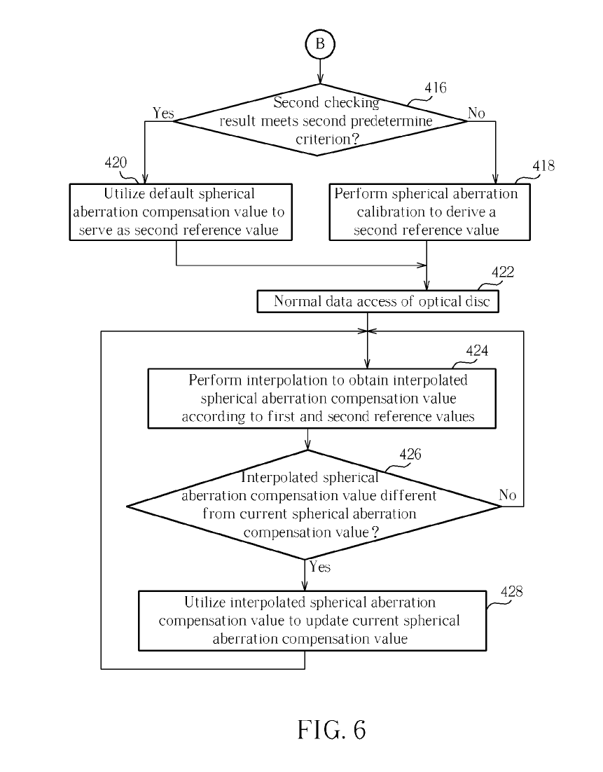

In the above embodiments, the spherical aberration calibration is performed to obtain spherical aberration compensation values corresponding to the first and second track positions (i.e., the inner track and outer track positions) at each recording layer. In the following, a modified spherical aberration compensation method is provided to skip spherical aberration calibration if a specific condition is met, thereby shortening the disc driver startup time. Please refer to FIG. 5 and FIG. 6. FIG. 5 is a flowchart illustrating a spherical aberration compensation method according to a third exemplary embodiment of the present invention. FIG. 6 is a continued flowchart of the flow shown in FIG. 5. Provided that the result is substantially the same, the steps are not limited to be executed in the exact order shown in FIG. 5 and FIG. 6. The exemplary spherical aberration compensation method includes following steps:
Step 400: Enable the servo control unit 114.
Step 402: Move the OPU 104 to a first track position (e.g., an inner track) on a recording layer of the optical disc 101.
Step 404: Check signal quality corresponding to a first reflected signal read by the OPU 104 to generate a first checking result when a default spherical aberration compensation value is applied to the optical disc drive 100.
Step 406: Check if the first checking result meets a first predetermine criterion. If yes, go to Step 410; otherwise, go to Step 408.
Step 408: Perform spherical aberration calibration at the first track position (e.g., the inner track) to derive a first spherical aberration compensation value serving as a first reference value. Go to Step 412.
Step 410: Utilize the default spherical aberration compensation value to directly serve as the first reference value.
Step 412: Move the OPU 104 to a second track position (e.g., an outer track) on the recording layer of the optical disc 101.
Step 414: Check signal quality corresponding to a second reflected signal read by the OPU 104 to generate a second checking result when the default spherical aberration compensation value is applied to the optical disc drive 100.
Step 416: Check if the second checking result meets a second predetermine criterion. If yes, go to Step 420; otherwise, go to Step 418.
Step 418: Perform spherical aberration calibration at the second track position (e.g., the outer track) to derive a second spherical aberration compensation value serving as a second reference value. Go to Step 422.
Step 420: Utilize the default spherical aberration compensation value to directly serve as the second reference value.
Step 422: Start normal data access of the optical disc 101.
Step 424: Perform an interpolation to obtain a third spherical aberration compensation value (i.e., an interpolated spherical aberration compensation value) corresponding to a third track position (i.e., a current track position during the normal data access) on the recording layer of the optical disc 101 according to the first (current), second (outer), and third (current) track positions and the first and second reference values.
Step 426: Check if the third spherical aberration compensation value (i.e., the interpolated spherical aberration compensation value) is different from a current spherical aberration compensation value. If yes, go to Step 428; otherwise, go to Step 424.
Step 428: Utilize the third spherical aberration compensation value (i.e., the interpolated spherical aberration compensation value) to update the current spherical aberration compensation value, and then go to Step 424.

In the flow shown in FIG. 5 and FIG. 6, the signal quality is examined to check if the spherical aberration calibration should be enabled to find the optimum spherical aberration compensation value at a specific track position. In this embodiment, the decoding error rate (e.g., PI error rate if the optical disc 101 is an HD-DVD or LDC error rate if then optical disc 101 is a BD) is estimated to generate each of the first and second checking results. The first predetermine criterion is used to examine whether the first checking result indicates that the decoding error rate is smaller than a first threshold, and the second predetermine criterion is used to examine whether the second checking result indicates that the decoding error rate is smaller than a second threshold. If the first predetermine criterion is met, meaning that the decoding error rate is low under the condition where the default spherical aberration compensation value is currently used, the first reference value is directly set by the default spherical aberration compensation value and no spherical aberration calibration is required. However, if the first predetermine criterion is not met, this implies that the decoding error rate is high under the condition where the default spherical aberration compensation value is currently used, and therefore necessitates the spherical aberration calibration for finding an optimum spherical aberration compensation value to determine the first reference value. Similarly, regarding the second reference value corresponding to the second track position on the recording layer of the optical disc 101, the above procedure for setting the first reference value is also used to determine the second reference value. It should be note that the above-mentioned first threshold and second threshold are preferably set by the same value; however, this is for illustrative purposes only, and is not meant to be a limitation of the present invention.

After the first and second reference values are obtained through either the default spherical aberration compensation value corresponding to the loaded optical disc 101 or the spherical aberration calibration actually performed on the loaded optical disc 101, the normal data access of the optical disc 101 begins. As Steps 422-428 in FIG. 6 and Steps 210-216 in FIG. 2 have similar operations, further description is omitted here for brevity.

It should be noted that the flow in FIG. 5 and FIG. 6 is applied to a single-layer optical disc for illustrative purposes only; however, a person skilled in the art can readily appreciate that the flow with adequate modifications can be applied to a multiple-layer optical disc. For example, the features directed to setting the first and second reference values through either the default spherical aberration compensation value of the loaded optical disc 101 or the spherical aberration calibration performed on the loaded optical disc 101 can be incorporated into the flow shown in FIG. 3 and FIG. 4 to achieve spherical aberration compensation of a dual-layer optical disc. Further description is omitted here for brevity.

In above embodiments shown in FIG. 2-FIG. 6, the spherical aberration compensation value at any track position during the normal data access operation is directly calculated by interpolation using the first and second reference values. The thickness of the optical disc, however, might be non-uniform from the inner track to the outer track due to process variation. A linear interpolation using the first and second reference values might derive a spherical aberration compensation value deviated from an optimum value for a specific track position between the first and second track positions (i.e., the inner and outer track positions). To improve the accuracy of spherical aberration compensation, a modified spherical aberration compensation method is provided.

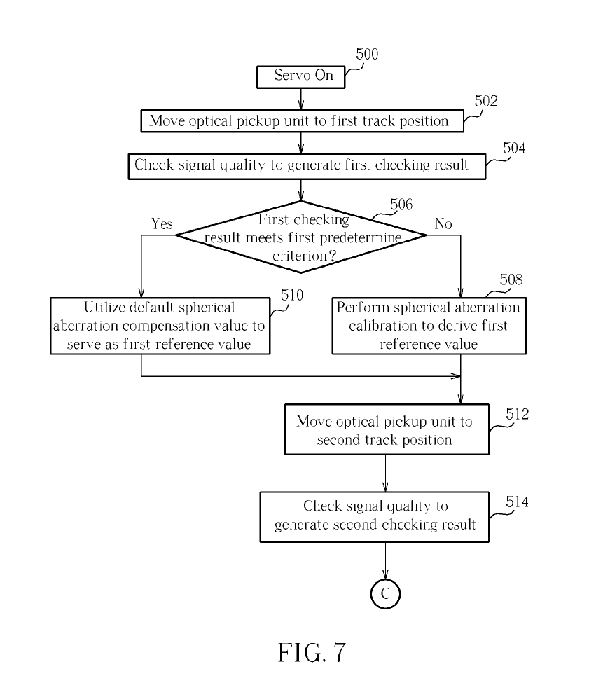

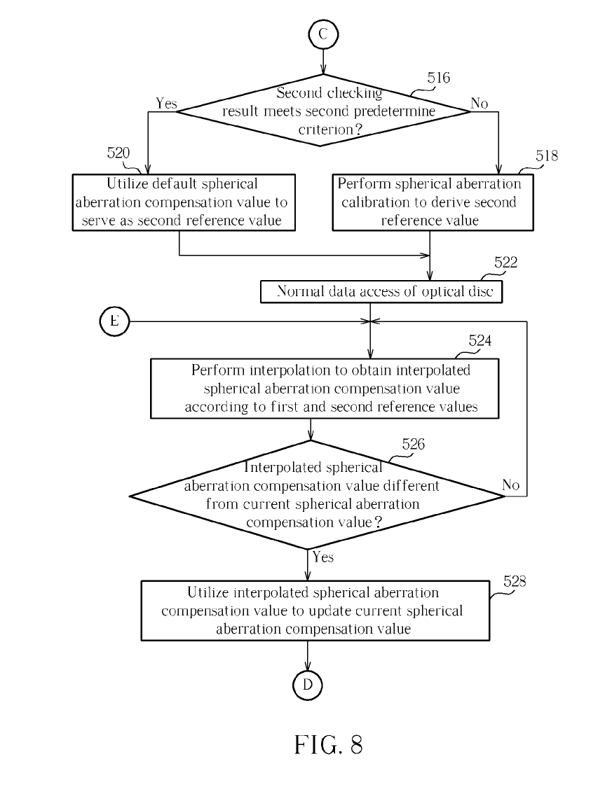

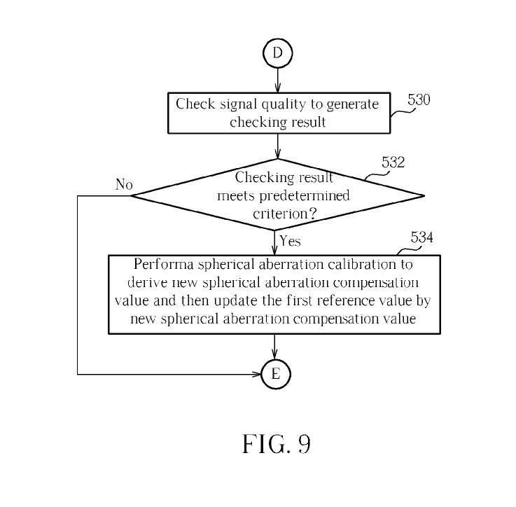

Please refer to FIG. 7-FIG. 9. FIG. 7 is a flowchart illustrating a spherical aberration compensation method according to a fourth exemplary embodiment of the present invention. FIG. 8 is a continued flowchart of the flow shown FIG. 7. FIG. 9 is a continued flowchart of the flow shown in FIG. 8. Provided that the result is substantially the same, the steps are not limited to be executed in the exact order shown in FIG. 7-FIG. 9. The exemplary spherical aberration compensation method includes following steps:
Step 500: Enable the servo control unit 114.
Step 502: Move the OPU 104 to a first track position (e.g., an inner track) on a recording layer of the optical disc 101.
Step 504: Check signal quality corresponding to a first reflected signal read by the OPU 104 to generate a first checking result when a default spherical aberration compensation value is applied to the optical disc drive 100.
Step 506: Check if the first checking result meets a first predetermine criterion. If yes, go to Step 510; otherwise, go to Step 508.
Step 508: Perform spherical aberration calibration at the first track position (e.g., the inner track) to derive a first spherical aberration compensation value serving as a first reference value. Go to Step 512.
Step 510: Utilize the default spherical aberration compensation value to serve as the first reference value.
Step 512: Move the OPU 104 to a second track position (e.g., an outer track) on the recording layer of the optical disc 101.
Step 514: Check signal quality corresponding to a second reflected signal read by the OPU 104 to generate a second checking result when the default spherical aberration compensation value is applied to the optical disc drive 100.
Step 516: Check if the second checking result meets a second predetermine criterion. If yes, go to Step 520; otherwise, go to Step 518.
Step 518: Perform spherical aberration calibration at the second track position (e.g., the outer track) to derive a second spherical aberration compensation value serving as a second reference value. Go to Step 522.
Step 520: Utilize the default spherical aberration compensation value to serve as the second reference value.
Step 522: Start normal data access of the optical disc 101.
Step 524: Perform an interpolation to obtain a third spherical aberration compensation value (i.e., an interpolated spherical aberration compensation value) corresponding to a third track position (i.e., a current track position during the normal data access) on the recording layer of the optical disc 101 according to the first and second reference values.
Step 526: Check if the third spherical aberration compensation value (i.e., the interpolated spherical aberration compensation value) is different from a current spherical aberration compensation value. If yes, go to Step 528; otherwise, go to Step 524.
Step 528: Utilize the third spherical aberration compensation value (i.e., the interpolated spherical aberration compensation value) to update the current spherical aberration compensation value applied to the optical disc drive 100.
Step 530: Check signal quality corresponding a reflected signal read by the OPU 104 from the third track position (i.e., the current track position) on the recording layer of the optical disc 101 to generate a checking result.
Step 532: Does the checking result meet a predetermined criterion? If yes, go to Step 534; otherwise, go to Step 524.
Step 534: Performa spherical aberration calibration at the third track position (i.e., the current track position) on the recording layer of the optical disc 101 to derive a new third spherical aberration compensation value corresponding to the third track position and then update the first reference value by the new third spherical aberration compensation value. Go to Step 524.

Steps 500-528 in FIG. 7 and FIG. 8 and Steps 400-428 in FIG. 5 and FIG. 6 have similar operations, and further description is omitted for brevity. The different between flows in FIG. 4-FIG. 5 and FIG. 7-FIG. 9 is that the exemplary spherical aberration compensation method of FIG. 7-FIG. 9 includes a signal quality checking procedure to determine if a spherical aberration calibration should be enabled to find an optimum spherical aberration compensation value used to replace the calculated spherical aberration compensation value derived from interpolation computation. In this embodiment, the occurrence of instant reading error (e.g., a decoder error or buffer error) is monitored to generate the checking result, and the predetermined criterion is used to examine whether the checking result indicates that the instant reading error occurs. In other words, when an inappropriate spherical aberration compensation value is used, the signal quality of the reflected signal read from the optical disc is poor, resulting in the instant reading error (e.g., decoder error or buffer error). In this exemplary embodiment, the first track position corresponds to an inner track position, and the second track position corresponds to an outer track position. Therefore, if the predetermine criterion is met, this implies that the instant reading error occurs under the condition where the interpolated spherical aberration compensation value derived in Step 524 is currently used, and therefore necessitates the spherical aberration calibration for finding an optimum spherical aberration compensation value to update the first reference value referenced by the interpolation computation. However, if the predetermine criterion is not met, meaning that there is no instant reading error under the condition where the calculated spherical aberration compensation value derived in Step 524 is currently used, the first reference value is not changed and can be used in the next interpolation computation.

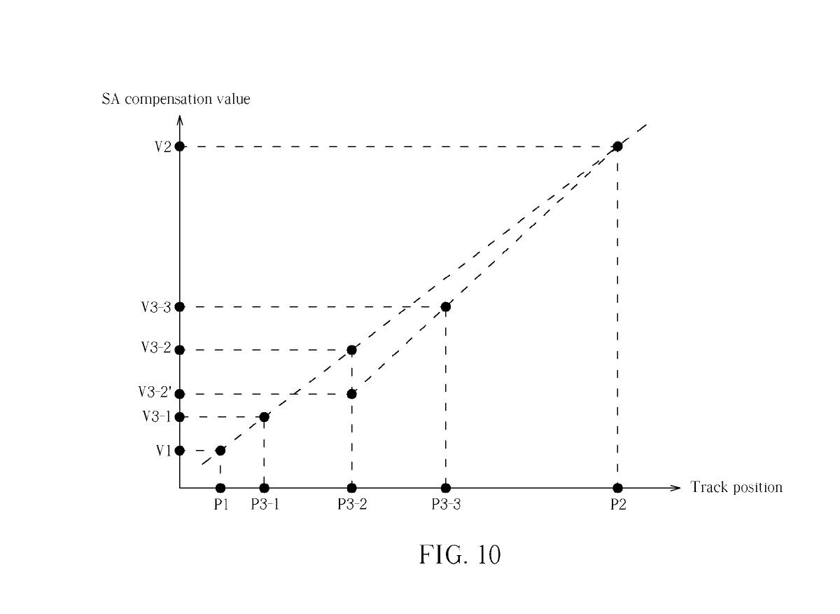

Please refer to FIG. 10. FIG. 10 is a diagram illustrating operation of determining the spherical aberration compensation value according to the flow shown in FIG. 7-FIG. 9. Assume that the first reference value derived for the first track position P1 (e.g., the inner track position) is V1, and the second reference value derived for the second track position P2 (e.g., the outer track position) is V2. After the normal data access of the optical disc 101 is started (Step 522), the SA compensation/calibration unit 110 performs an interpolation to obtain a third spherical aberration compensation value V3-1 corresponding to a third track position P3-1 (i.e., a current track position during the normal data access) on the recording layer of the optical disc 101 according to the first, second, and third track positions P1, P2, P3-1 and the first and second reference values V1, V2. The calculated spherical aberration compensation value V3-1 is then fed into the SA driver 112 and utilized by the SA driver 112 to control the spherical aberration compensation applied to the optical disc drive. Because no instant reading error is found after the current spherical aberration compensation value is set by the calculated spherical aberration compensation value V3-1, the SA compensation/calibration unit 110 does not change the first reference value currently set by V1. Therefore, when the OPU 104 moves along the spiral track on the optical disc 101 and the current track position is changed to P3-2, the SA compensation/calibration unit 110 performs an interpolation to obtain another third spherical aberration compensation value V3-2 corresponding to a new third track position P3-2 (i.e., the current track position during the normal data access) on the recording layer of the optical disc 101 according to the first, second, and third track positions P1, P2, P3-2 and the first and second reference values V1, V2. Suppose that the instant reading error occurs after the current spherical aberration compensation value is updated by the calculated spherical aberration compensation value V3-2, the SA compensation/calibration unit 110 activates a spherical aberration calibration to find an optimum spherical aberration compensation value V3-2′, and provides the spherical aberration compensation value V3-2′ to the SA driver 112 to replace the calculated spherical aberration compensation value V3-2 derived from interpolation computation. In this way, the first reference value V1 is updated by the spherical aberration compensation value V3-2′ derived from spherical aberration calibration now. Next, when the OPU 104 keeps moving along the spiral track on the optical disc 101 and the current track position is updated to P3-3, the SA compensation/calibration unit 110 performs an interpolation to obtain another third spherical aberration compensation value V3-3 corresponding to the new third track position P3-3 (i.e., the current track position during the normal data access) on the recording layer of the optical disc 101 according to track positions P3-2, P3-3, and P2 and the first and second reference values V3-2′ and V2. As a result, a more accurate spherical aberration compensation value can be obtained from interpolation of reference values which are adaptively updated when instant reading error occurs.

It should be noted that the flow in FIG. 7-FIG. 9 is applied to a single-layer optical disc for illustrative purposes only; however, a person skilled in the art can readily appreciate that the flow with adequate modifications can be applied to a multiple-layer optical disc. For example, the features directed to adaptively updating the reference values through the spherical aberration calibration can be incorporated into the flow shown in FIG. 3 and FIG. 4 to achieve spherical aberration compensation of a dual-layer optical disc. Further description is omitted here for brevity.

The exemplary spherical aberration compensation methods shown in FIG. 2-FIG. 9 are for illustrative purposes only. After reading above disclosure, a person skilled in the art can readily derive an alternative spherical aberration compensation method including one or more technical features employed in the exemplary embodiments shown in FIG. 2-FIG. 9. This alternative design still obeys the spirit of the present invention, and falls in the scope of the present invention.

Those skilled in the art will readily observe that numerous modifications and alterations of the device and method may be made while retaining the teachings of the invention.

What is claimed is:

1. A spherical aberration compensation method of an optical storage device, comprising:
(a-1) deriving a first spherical aberration compensation value corresponding to a first track position on a recording layer of an optical storage medium to serve as a first reference value;
(b-1) deriving a second spherical aberration compensation value corresponding to a second track position on the recording layer of the optical storage medium to serve as a second reference value; and
(c) deriving a third spherical aberration compensation value corresponding to a third track position on the recording layer of the optical storage medium according to the first and second reference values.

2. The method of claim 1, wherein step (a-1) comprises:
performing a spherical aberration calibration at the first track position on the recording layer of the optical storage medium to derive the first spherical aberration compensation value.

3. The method of claim 2, wherein step (b-1) comprises:
performing the spherical aberration calibration at the second track position on the recording layer of the optical storage medium to derive the second spherical aberration compensation value.

4. The method of claim 1, where step (c) comprises:
performing an interpolation to obtain the third spherical aberration compensation value according to the first and second reference values.

5. The method of claim 1, further comprising:
(d) updating the first reference value by the third spherical aberration compensation value when the third spherical aberration compensation value is different from the first spherical aberration compensation value;
(e) keeping the first reference value unchanged when the third spherical aberration compensation value is identical to the first spherical aberration compensation value; and
(f) deriving a fourth spherical aberration compensation value corresponding to a fourth track position on the first recording layer of the optical storage medium according to the first and second reference values.

6. The method of claim 5, wherein the third track position is between the first and second track position, and the fourth track position is between the third track position and the second track position.

7. The method of claim 5, further comprising:
before deriving the fourth spherical aberration compensation value, applying the third spherical aberration compensation value to the optical storage device and then checking signal quality corresponding a reflected signal read by the optical storage device from the third track position on the recording layer of the optical storage medium to generate a checking result;
when the checking result meets a predetermine criterion, performing a spherical aberration calibration at the third track position on the recording layer of the optical storage medium to derive a new third spherical aberration compensation value corresponding to the third track position and then updating the first reference value by the new third spherical aberration compensation value; and
when the checking result does not meet the predetermine criterion of the signal quality is not met, performing step (e).

8. The method of claim 7, wherein the checking result is indicative of occurrence of an instant reading error, and the predetermine criterion is met when the instant reading error occurs.

9. The method of claim 1, wherein the optical storage medium has a plurality of recording layers, the steps (a-1), (b-1), and (c) are performed upon each of the recording layers.

10. The method of claim 1, further comprising:
(a-0) checking signal quality corresponding a first reflected signal read by the optical storage device to generate a first checking result when a default spherical aberration compensation value is applied to the optical storage device;
wherein when the first checking result meets a first predetermine criterion, the default spherical aberration compensation value is utilized to serve as the first reference value; and when the checking result does not meet the first predetermine criterion, step (a-1) is performed.

11. The method of claim 10, further comprising:
(b-0) checking signal quality corresponding a second reflected signal read by the optical storage device to generate a second checking result when the default spherical aberration compensation value is applied to the optical storage device;
wherein when the second checking result meets a second predetermine criterion, the default spherical aberration compensation value is utilized to serve as the second reference value; and when the second checking result does not meet the second predetermine criterion, step (b-1) is performed.

12. The method of claim 11, wherein the first checking result is indicative of a first decoding error rate, the second checking result is indicative of a second decoding error rate, the first predetermine criterion is met when the first decoding error rate is smaller than a first threshold, and the second predetermine criterion is met when the second decoding error rate is smaller than a second threshold.

13. The method of claim 11, wherein the optical storage medium has a plurality of recording layers, the steps (a-0), (a-1), (b-0), (b-1), and (c) are performed upon each of the recording layers.

14. A spherical aberration compensation method of an optical storage device, comprising:
applying a default spherical aberration compensation value to the optical storage device and then checking a signal quality corresponding a reflected signal read by the optical storage device from a specific track position on a recording layer of an optical storage medium to generate a checking result;
when the checking result meets a predetermine criterion, utilizing the default spherical aberration compensation value to serve as a target spherical aberration compensation value corresponding to the specific track position on the recording layer of the optical storage medium; and
when the checking result does not meet the predetermine criterion, performing a spherical aberration calibration at the specific track position on the recording layer of the optical storage medium to derive the target spherical aberration compensation value.
